(19) United States
(12) Patent Application Publication
(10) Pub. No.: US 2026/0016047 A1
(43) Pub. Date: Jan. 15, 2026

(54) E-AXLE BEARING PRELOAD SPRING CONFIGURATION FOR IMPROVED PACKAGING

(71) Applicant: Schaeffler Technologies AG & Co. KG, Herzogenaurach (DE)

(72) Inventors: Kyle Nelson, Delaware, OH (US); David Kinion, Cuyahoga Falls, OH (US); Nicholas Wurst, Akron, OH (US)

(73) Assignee: Schaeffler Technologies AG & Co. KG, Herzogenaurach (DE)

(21) Appl. No.: 18/768,408

(22) Filed: Jul. 10, 2024

(51) Int. Cl. F16C 25/08; F16C 33/78

(52) U.S. Cl. CPC F16C 25/083; F16C 33/7806; F16C 2326/02; F16C 2380/26

(57) ABSTRACT

A bearing arrangement utilizing a typical lip seal pressed into a bore to act as a reacting spring surface which keeps a bearing outer race preloaded to prevent unintentional bad bearing operation (e.g., outer race spinning or ball sliding). This spring reacting surface serves to discourage, for example, outer race spinning or ball sliding, packaged in a tight, space efficient location to permit critical space to be used for other functions. Aspects include retention feature for retaining a biasing element in the bore prior to assembly.

### TECHNICAL FIELD

The present disclosure relates generally to an electric axle for an electric or hybrid vehicle, and more specifically to a bearing arrangement of an electric axle.

### BACKGROUND

In electric and hybrid vehicle designs, light-weighting and compact packaging are desirable to enhance the performance and range of the vehicle.

### SUMMARY

Embodiments according to this disclosure provide reduced product complexity, and allow for multifunctional use of existing components which would otherwise have required creation of specific interfaces, introducing extra costs and packaging requirements. Aspects of the present disclosure are directed to bearing arrangements that utilize a typical lip seal pressed into a bore to act as a reacting spring surface which keeps a bearing outer race preloaded to prevent unintentional bad bearing operation (e.g., outer race spinning or ball sliding). This spring reacting surface serves to discourage, for example, outer race spinning or ball sliding, packaged in a tight, space efficient location to permit critical space to be used for other functions.

In accordance with one aspect, an e-axle assembly comprises a housing, an electric motor supported in the housing and including a rotor shaft, a bearing supporting the rotor shaft for rotation in the housing, a biasing element for preloading the bearing, and a seal for sealing the shaft to the housing. The seal is engaged with the biasing element and provides a spring reaction surface for the biasing element to preload the bearing.

The housing can include a central portion and an end housing assembly attached to the central portion and having a bore, an inner race of the bearing is pressed on the rotor shaft and an outer race of the bearing is slip fit in the bore of the end housing assembly. The seal can be pressed into the bore of the end housing assembly. The biasing element can be received in an expansion pocket of the end housing assembly, the expansion pocking having a larger cross-sectional diameter than a portion of the bore in which the outer race of the bearing is received, the biasing element having a larger cross-sectional diameter than the portion of the bore in which the outer race of the bearing is received, whereby the biasing element is retained within the expansion pocket. The biasing element can include a wave spring. The bearing can be located radially inwardly of the biasing element and the seal. The end housing assembly can include an axle bearing supporting an axle shaft. The axle shaft can be concentric with the rotor shaft. The end housing assembly can include a resolver.

In accordance with another aspect, a method of assembling an e-axle comprises inserting a seal into bore of an end housing assembly, inserting a biasing element into the bore of the end housing assembly, and telescoping the bore over an outer race of a bearing fixed to a rotor shaft of an electric motor of the e-axle. The seal is engaged with the biasing element and provides a spring reaction surface for the biasing element to preload the bearing.

The biasing element can be received in an expansion pocket in the bore of the end housing assembly, the expansion pocking having a larger cross-sectional diameter than a portion of the bore in which outer race of the bearing is received, the biasing element having a larger cross-sectional diameter than the portion of the bore in which the outer race of the bearing is received, whereby the biasing element is retained within the expansion pocket prior to telescoping the bore over the outer race of a bearing. The biasing element can include a wave spring. The biasing element can be located axially between the seal and the bearing. Inserting the biasing element into the bore of the end housing assembly can include radially compressing the biasing element and passing the biasing element axially through the portion of the bore in which outer race of the bearing is received to the expansion pocket.

In accordance with another aspect, an end housing assembly for an e-axle comprises a bore, wherein the bore includes a portion for receiving an outer race of a bearing and an expansion pocket, the expansion pocking having a larger cross-sectional diameter than the portion of the bore for receiving the outer race of a bearing, a biasing element having a larger cross-sectional diameter than the portion of the bore for receiving the outer race of the bearing, the biasing element being retained in the expansion pocket of the bore, and a seal supported in the bore, wherein the biasing element is axially between the seal and the portion of the bore for receiving the outer race of a bearing.

Additional embodiments are disclosed herein.

### BRIEF DESCRIPTION OF THE DRAWINGS

The foregoing Summary and the following Detailed Description will be better understood when read in conjunction with the appended drawings, which illustrate a preferred embodiment of the disclosure. In the drawings:

FIG. 1 is a cross-sectional view of an exemplary e-axle in accordance with the present disclosure; and

FIG. 2 is an enlarged portion of FIG. 1 showing an end housing of the e-axle rotated to a typical installation orientation.

### DETAILED DESCRIPTION

Certain terminology is used in the following description for convenience only and is not limiting. The words “front,” “rear,” “upper” and “lower” designate directions in the drawings to which reference is made. The words “inwardly” and “outwardly” refer to directions toward and away from the parts referenced in the drawings. “Axially” refers to a direction along the axis of a shaft. A reference to a list of items that are cited as “at least one of a, b, or c” (where a, b, and c represent the items being listed) means any single one of the items a, b, or c, or combinations thereof. The terminology includes the words specifically noted above, derivatives thereof and words of similar import.

Embodiments of the present disclosure are described herein. It should be appreciated that like drawing numbers appearing in different drawing views identify identical, or functionally similar, structural elements. Also, it is to be understood that the disclosed embodiments are merely examples and other embodiments can take various and alternative forms. The figures are not necessarily to scale; some features could be exaggerated or minimized to show details of particular components. Therefore, specific structural and functional details disclosed herein are not to be interpreted as limiting, but merely as a representative basis for teaching one skilled in the art to variously employ the embodiments. As those of ordinary skill in the art will understand, various features illustrated and described with reference to any one of the figures can be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desired for particular applications or implementations.

The terminology used herein is for the purpose of describing particular aspects only and is not intended to limit the scope of the present disclosure. Unless defined otherwise, all technical and scientific terms used herein have the same meaning as commonly understood to one of ordinary skill in the art to which this disclosure belongs. Although any methods, devices or materials similar or equivalent to those described herein can be used in the practice or testing of the disclosure, the following example methods, devices, and materials are now described.

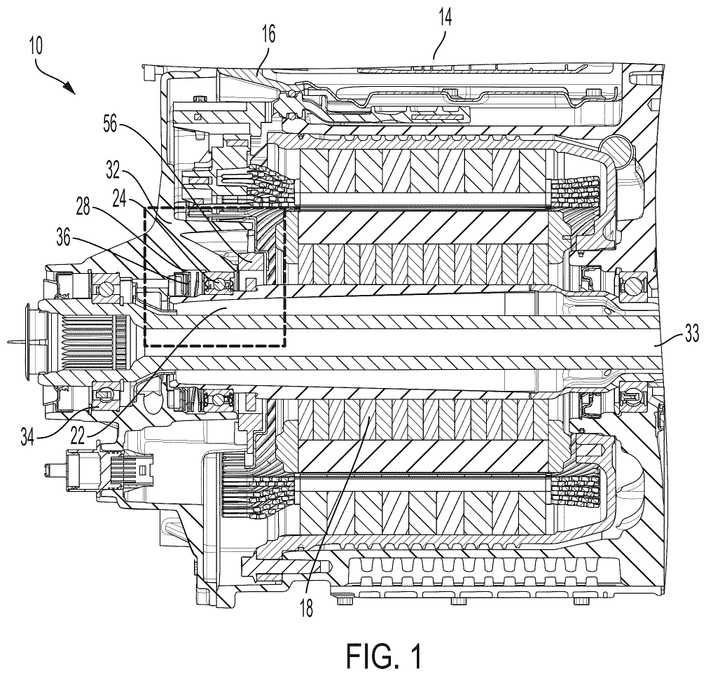

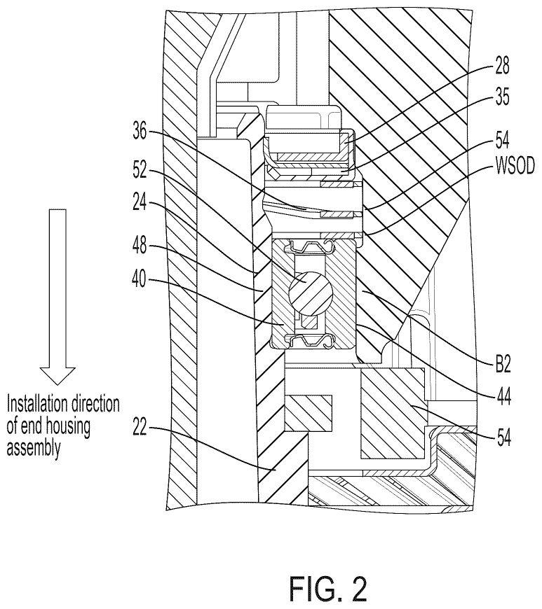

Referring to FIGS. 1 and 2, an exemplary e-axle assembly in accordance with the present disclosure is illustrated and identified generally by reference numeral 10. The e-axle assembly 10 generally includes a housing 14 including a central portion 16 in which an electric motor 18 is supported. The electric motor 18 includes a rotor shaft 22 which is supported in the housing 14 for rotation by a bearing 24. A dynamic lip seal 28 is provided for sealing the rotor shaft 22 to an end housing assembly 32 of the housing 14. Th e-axle assembly 10 also includes an axle shaft 33 supported by an axle bearing 34 in the end housing assembly 32.

In accordance with the present disclosure, the lip seal 28 provides a spring reaction surface 35 for a wave spring 36 for preloading the bearing 24. This arrangement provides a more compact solution, allowing for smaller bearing sizes, as the wave spring's reacting surface can be brought inward radially to engage the lip seal 28 directly. This configuration also eliminates the need for a bearing carrier which is typically used to support the bearing and provide a spring reaction surface to the wave spring.

The bearing 24 has its inner race 40 pressed to rotor shaft 22. In this e-axle configuration, an outer race 44 of bearing 24 is free to slip into a bore 48 of the end housing assembly 32 during assembly. However, during operation the drag torque of the bearing and other internal friction can cause rolling elements 52 of the bearing 24 to slide instead of roll, and/or the outer race 44 to slip with respect to its installation bore. The wave spring 36 serves a sole function of introducing enough axial load into the bearing 24 to prevent ball/race slippage, which would induce a high heat load into the parts, causing early failure.

In FIG. 2, an enlarged portion of the e-axle assembly 10 is shown oriented in the direction by which the end housing assembly 32 will be assembled to the rest of the e-axle assembly 10. The end housing assembly 32 will be lowered onto the rest of the e-axle assembly 10 including the rotor shaft 22 and the bearing 24. This orientation is favorable for production from a cost and logistics standpoint. However, this orientation can result in the wave spring 36 dislodging or otherwise coming out of place within the end housing assembly 32 due to gravity or other forces. Accordingly, the wave spring 36 has an outside diameter WSOD that is larger than the inside diameter of the bore 48 (bearing slip fit diameter B2) of the end housing assembly 32 in which the bearing 24 is to be received. The bearing pre-load wave spring 36 can be compressed radially for installation to the end housing assembly 32 (e.g., similar to a multi-wound snap ring). Once the wave spring 36 clears the bearing slip fit diameter B2, it will then ‘snap’ into an expansion pocket 54 of the end housing assembly 32 wherein it will be retained so the end housing assembly 32 can be installed while keeping the wave spring 36 in place.

The assembly process generally includes pressing the bearing 24 onto the rotor shaft 22. The seal 28 is pressed into the end housing assembly 32. A resolver 56 is fixed to the end housing assembly 32. Wave spring 36 is placed into the expansion pocket 52 of the end housing assembly 32. Finally, the end housing assembly 32 is slid over the rotor shaft 22.

While exemplary embodiments are described above, it is not intended that these embodiments describe all possible forms encompassed by the claims. The words used in the specification are words of description rather than limitation, and it is understood that various changes can be made without departing from the spirit and scope of the disclosure. As previously described, the features of various embodiments can be combined to form further embodiments of the disclosure that may not be explicitly described or illustrated. While various embodiments could have been described as providing advantages or being preferred over other embodiments or prior art implementations with respect to one or more desired characteristics, those of ordinary skill in the art recognize that one or more features or characteristics can be compromised to achieve desired overall system attributes, which depend on the specific application and implementation. These attributes can include, but are not limited to cost, strength, durability, life cycle cost, marketability, appearance, packaging, size, serviceability, weight, manufacturability, ease of assembly, etc. As such, to the extent any embodiments are described as less desirable than other embodiments or prior art implementations with respect to one or more characteristics, these embodiments are not outside the scope of the disclosure and can be desirable for particular applications.

Having thus described the present embodiments in detail, it is to be appreciated and will be apparent to those skilled in the art that many physical changes, only a few of which are exemplified in the detailed description of the disclosure, could be made without altering the inventive concepts and principles embodied therein.

It is also to be appreciated that numerous embodiments incorporating only part of the preferred embodiment are possible which do not alter, with respect to those parts, the inventive concepts and principles embodied therein.

The present embodiment and optional configurations are therefore to be considered in all respects as exemplary and/or illustrative and not restrictive, the scope of the disclosure being indicated by the appended claims rather than by the foregoing description, and all alternate embodiments and changes to this embodiment which come within the meaning and range of equivalency of said claims are therefore to be embraced therein.

### LOG OF REFERENCE NUMERALS

10 e-axle assembly
14 housing
16 central portion
18 electric motor
22 rotor shaft
28 seal
32 end housing assembly
33 axle shaft
34 axle bearing
35 spring reaction surface
36 wave spring
40 inner race
44 outer race
48 bore
52 rolling elements
54 expansion pocket
WSOD wave spring outside diameter
B2 bearing slip fit diameter

What is claimed is:

1. An e-axle assembly comprising:
a housing;
an electric motor supported in the housing and including a rotor shaft;
a bearing supporting the rotor shaft for rotation in the housing;
a biasing element for preloading the bearing; and
a seal for sealing the shaft to the housing;
wherein the seal is engaged with the biasing element and provides a spring reaction surface for the biasing element to preload the bearing.

2. The e-axle assembly according to claim 1, wherein the housing includes an end housing assembly having a bore, and wherein an inner race of the bearing is pressed on the rotor shaft and an outer race of the bearing is slip fit in the bore of the end housing assembly.

3. The e-axle assembly according to claim 2, wherein the seal is pressed into the bore of the end housing assembly.

4. The e-axle assembly according to claim 3, wherein the biasing element is received in an expansion pocket of the end housing assembly, the expansion pocking having a larger cross-sectional diameter than a portion of the bore in which the outer race of the bearing is received, the biasing element having a larger cross-sectional diameter than the portion of the bore in which the outer race of the bearing is received, whereby the biasing element is retained within the expansion pocket.

5. The e-axle assembly according to claim 4, wherein the biasing element includes a wave spring.

6. The e-axle assembly according to claim 1, wherein the bearing is located radially inwardly of the biasing element and the seal.

7. The e-axle assembly according to claim 1, wherein the end housing assembly includes an axle bearing supporting an axle shaft.

8. The e-axle assembly according to claim 7, wherein the axle shaft is concentric with the rotor shaft

9. The e-axle assembly according to claim 1, wherein the end housing assembly includes a resolver.

10. A method of assembling an e-axle comprising:
inserting a seal into bore of an end housing assembly;
inserting a biasing element into the bore of the end housing assembly; and
telescoping the bore over an outer race of a bearing fixed to a rotor shaft of an electric motor of the e-axle;
wherein the seal is engaged with the biasing element and provides a spring reaction surface for the biasing element to preload the bearing.

11. The method of claim 10, wherein the biasing element is received in an expansion pocket in the bore of the end housing assembly, the expansion pocking having a larger cross-sectional diameter than a portion of the bore in which outer race of the bearing is received, the biasing element having a larger cross-sectional diameter than the portion of the bore in which the outer race of the bearing is received, whereby the biasing element is retained within the expansion pocket prior to telescoping the bore over the outer race of a bearing.

12. The method of claim 11, wherein the biasing element includes a wave spring.

13. The method according to claim 11, wherein the biasing element is located axially between the seal and the bearing.

14. The method according to claim 11, wherein inserting the biasing element into the bore of the end housing assembly includes radially compressing the biasing element and passing the biasing element axially through the portion of the bore in which outer race of the bearing is received to the expansion pocket.

15. An end housing assembly for an e-axle comprising a bore, wherein the bore includes a portion for receiving an outer race of a bearing and an expansion pocket, the expansion pocking having a larger cross-sectional diameter than the portion of the bore for receiving the outer race of a bearing, a biasing element having a larger cross-sectional diameter than the portion of the bore for receiving the outer race of the bearing, the biasing element being retained in the expansion pocket of the bore, and a seal supported in the bore, wherein the biasing element is axially between the seal and the portion of the bore for receiving the outer race of a bearing.
